(19) United States
(12) Patent Application Publication
(10) Pub. No.: US 2022/0121981 A1
(43) Pub. Date: Apr. 21, 2022

(54) Cognitive Error Recommendation Based on Log Data

(71) Applicant: Oracle International Corporation, Redwood Shores, CA (US)

(72) Inventors: Anshuk Pal CHAUDHURI, Kolkata (IN); Alex Mathew JAYARAJ, Chennai (IN); Lohit Kumar PRADHAN, Khurda (IN); Uzma Iqbal MOMIN, Thane (IN)

(21) Appl. No.: 17/073,525

(22) Filed: Oct. 19, 2020

(51) Int. Cl. G06N 20/00; G06F 16/245

(52) U.S. Cl. CPC G06N 20/00; G06F 16/245

(57) ABSTRACT

Embodiments generate machine learning recommendations using log data. Log data can be ingested to generate an event stream for cloud systems, where each of the cloud systems comprises a combination of components, and the cloud systems present heterogenous system architectures. The generated event streams can be processed to generate a data set, where the data set include issue labels for issues experienced by the cloud systems. Features from the generated data set can be extracted. Issue recommendations can be generated using machine learning algorithms based on the extracted features and the generated data set, where the issue recommendations are generated using a hybrid of collaborative based machine learning filtering and content based machine learning filtering.

### FIELD

The embodiments of the present disclosure generally relate to generating machine learning recommendations using log data.

### BACKGROUND

Modern software as a service (SaaS), platform as a service (PaaS), infrastructure as a service (IaaS), and other cloud-based systems or platforms are implemented using cloud and/or distributed hardware. These systems often include various levels of configuration, customization, and combinations of service that result in heterogeneous environments and layers of complexity. In addition, the data generated by the systems that implement the heterogeneous environments is voluminous, complicated, and often contains challenging temporal conditions. Accordingly, machine learning predictions that utilize this data to prioritize issues and/or errors can improve the usability of these systems.

### SUMMARY

The embodiments of the present disclosure are generally directed to systems and methods for generating machine learning recommendations using log data. Log data can be ingested to generate an event stream for cloud systems, where each of the cloud systems comprises a combination of components, and the cloud systems present heterogenous system architectures. The generated event streams can be processed to generate a data set, where the data set include issue labels for issues experienced by the cloud systems. Features from the generated data set can be extracted. Issue recommendations can be generated using machine learning algorithms based on the extracted features and the generated data set, where the issue recommendations are generated using a hybrid of collaborative based machine learning filtering and content based machine learning filtering.

Features and advantages of the embodiments are set forth in the description which follows, or will be apparent from the description, or may be learned by practice of the disclosure.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a system for generating machine learning recommendations using log data according to an example embodiment.

FIG. 2 illustrates a block diagram of a computing device operatively coupled to a prediction system according to an example embodiment.

FIGS. 3-5 illustrate a system for processing log data according to an example embodiment.

FIGS. 6-7 illustrate a data pipeline for generating issue recommendations according to an example embodiment.

FIG. 8 illustrates sample processed data according to an example embodiment.

FIGS. 9A-9C illustrate output from data wrangling according to an example embodiment.

FIGS. 10-11 illustrate issue recommendation output according to an example embodiment.

FIG. 12 illustrates a flow diagram for generating machine learning recommendations using log data according to an example embodiment.

### DETAILED DESCRIPTION

Embodiments generate machine learning recommendations using log data. A cloud service provider can implement a number of different system architectures, such as for different end users or customers. For example, system implementations can include combinations of cloud services, combinations of platform configurations, or other suitable combinations of components that present a system architecture. In some embodiments, the systems include different combinations of components that present unique heterogeneous system architectures.

Accordingly, a given cloud service provider with a number of customers/systems can result in a large number of heterogenous environments with complex layers of components, where a variety of errors, problems, inefficiencies, or general issues can be encountered. Developing an understanding of which issues are impactful across different customers/systems (or for specific customers/systems) can enable resources to be focused and prioritized (at times even before the errors are actually reported). In some embodiments, the software and hardware the implement the plurality of systems generate log data. For example, each system (with a given system architecture) can generate log data over time. In addition, while the systems are executing software, errors, inefficiencies, or general issues can be encountered that are reflected in the log data.

In some embodiments, this log data is processed to generate a data set for machine learning. The generated data set can include issue labels, or labels for a sequence of log data/entries that represent an issue encountered when implementing the systems. In addition, features can be extracted from the data set that reflect characteristics of the issue labels. In some embodiments, issue recommendations can be generated using machine learning algorithms based on the extracted features and the generated data set. For example, collaborative based machine learning filtering and content based machine learning filtering can be used to generate a hybrid recommendation of issues. In some embodiments, the hybrid recommendation of issues can represent errors that impact across different ones of the system architectures and/or errors that are impactful to the systems.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

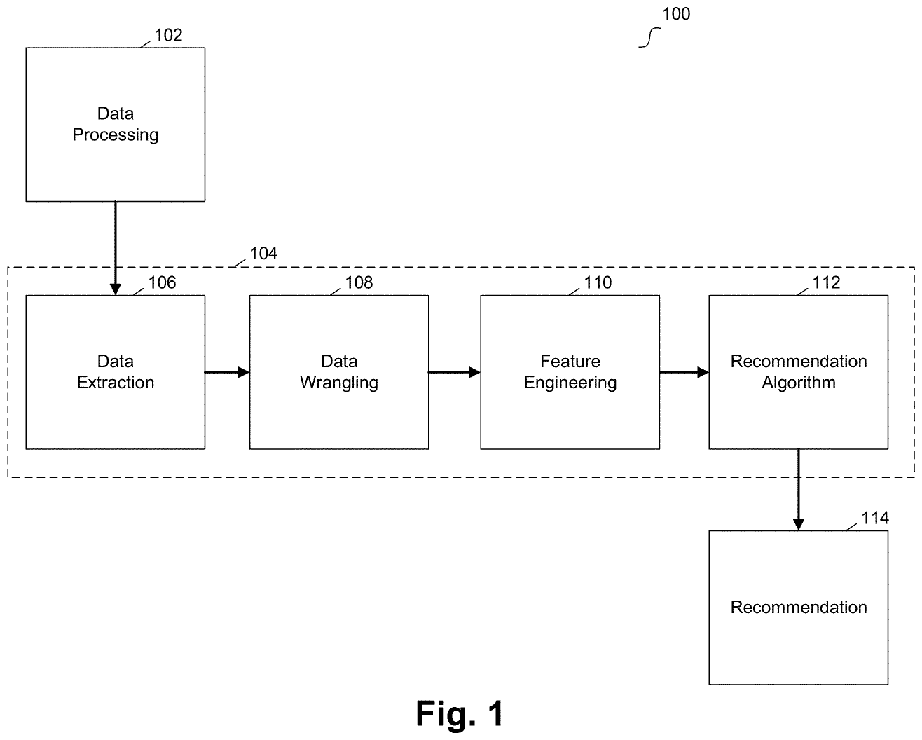

FIG. 1 illustrates a system for generating machine learning recommendations using log data according to an example embodiment. System 100 includes data processing 102, pipeline 104, data extraction 106, data wrangling 108, feature engineering 110, recommendation algorithm 112, and recommendation 114. For example, system 100 can be used to process log data (e.g. data generated by heterogeneous systems) and generate machine learning recommendations for issue or error mitigation.

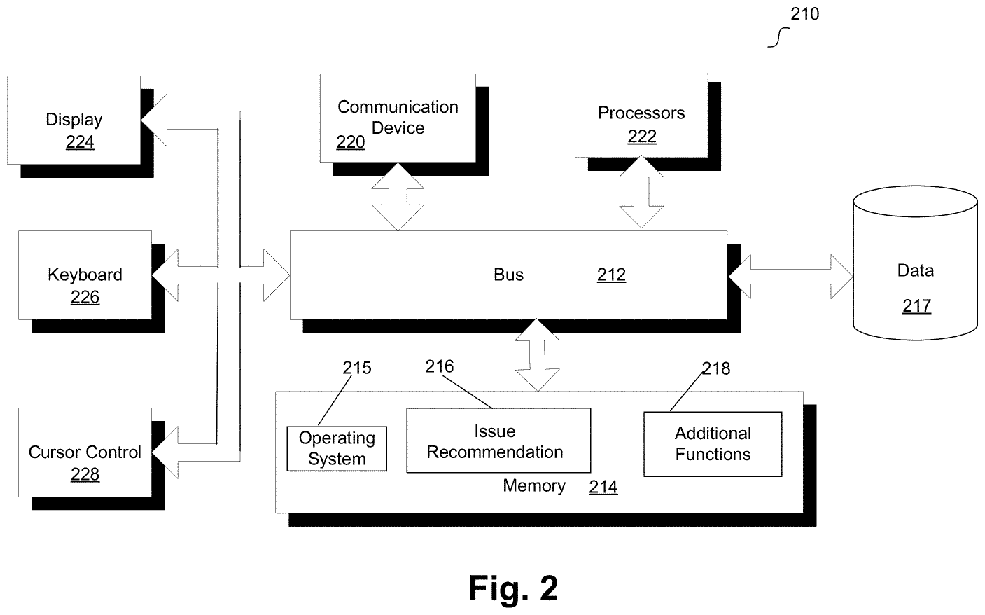

FIG. 2 is a block diagram of a computer server/system 210 in accordance with embodiments. As shown in FIG. 2, system 210 may include a bus device 212 and/or other communication mechanism(s) configured to communicate information between the various components of system 210, such as processor 222 and memory 214. In addition, communication device 220 may enable connectivity between processor 222 and other devices by encoding data to be sent from processor 222 to another device over a network (not shown) and decoding data received from another system over the network for processor 222.

For example, communication device 220 may include a network interface card that is configured to provide wireless network communications. A variety of wireless communication techniques may be used including infrared, radio, Bluetooth®, Wi-Fi, and/or cellular communications. Alternatively, communication device 220 may be configured to provide wired network connection(s), such as an Ethernet connection.

Processor 222 may include one or more general or specific purpose processors to perform computation and control functions of system 210. Processor 222 may include a single integrated circuit, such as a micro-processing device, or may include multiple integrated circuit devices and/or circuit boards working in cooperation to accomplish the functions of processor 222. In addition, processor 222 may execute computer programs, such as operating system 215, issue recommendation component 216, and other applications 218, stored within memory 214.

System 210 may include memory 214 for storing information and instructions for execution by processor 222. Memory 214 may contain various components for retrieving, presenting, modifying, and storing data. For example, memory 214 may store software modules that provide functionality when executed by processor 222. The modules may include an operating system 215 that provides operating system functionality for system 210. The modules can include an operating system 215, issue recommendation component 216, as well as other applications modules 218. Operating system 215 provides operating system functionality for system 210. Issue recommendation component 216 may provide system functionality for recommending issues from data logs, or may further provide any other functionality of this disclosure. In some instances, issue recommendation component 216 may be implemented as an in-memory configuration.

Non-transitory memory 214 may include a variety of computer-readable medium that may be accessed by processor 222. For example, memory 214 may include any combination of random access memory (“RAM”), dynamic RAM (“DRAM”), static RAM (“SRAM”), read only memory (“ROM”), flash memory, cache memory, and/or any other type of non-transitory computer-readable medium. Processor 222 is further coupled via bus 212 to a display 224, such as a Liquid Crystal Display (“LCD”). A keyboard 226 and a cursor control device 228, such as a computer mouse, are further coupled to communication device 212 to enable a user to interface with system 210.

In some embodiments, system 210 can be part of a larger system. Therefore, system 210 can include one or more additional functional modules 218 to include the additional functionality. Other applications modules 218 may include the various modules of the Oracle® Cloud Infrastructure (“OCI”), Oracle Application Express (“APEX”), or Oracle Visual Builder (“VB”), for example. A database 217 is coupled to bus 212 to provide centralized storage for modules 216 and 218 and to store, for example, wireless device activity, and in some embodiments, user profiles, transactions history, etc. Database 217 can store data in an integrated collection of logically-related records or files. Database 217 can be an operational database, an analytical database, a data warehouse, a distributed database, an end-user database, an external database, a navigational database, an in-memory database, a document-oriented database, a real-time database, a relational database, an object-oriented database, Hadoop Distributed File System (“HFDS”), or any other database known in the art.

Although shown as a single system, the functionality of system 210 may be implemented as a distributed system. For example, memory 214 and processor 222 may be distributed across multiple different computers that collectively represent system 210. In one embodiment, system 210 may be part of a device (e.g., smartphone, tablet, computer, etc.).

In an embodiment, system 210 may be separate from the device, and may remotely provide the described functionality for the device. Further, one or more components of system 210 may not be included. For example, for functionality as a user or consumer device, system 210 may be a smartphone or other wireless device that includes a processor, memory, and a display, does not include one or more of the other components shown in FIG. 2, and includes additional components not shown in FIG. 2.

Embodiments include an issue/error prioritization recommendation system that can be applied to a variety of products, solutions, or applications based on log data. Embodiments of the recommender system can recommend a prioritized list of issues/errors across customers or system implementations, at times before these are reported by customers/stakeholders. Thus, products and services can be maintained at a robust service level by anticipating potential problems.

Embodiments of this model provide a framework for using a series of feature selection mechanisms and a pipeline of recommendation algorithms for a multi-label classification problem using machine learning algorithms. For example, a hybrid recommendation system can provide issue recommendations based on content based filtering and collaborative filtering. An example implementation is provided using a low code development platform which aids in developing applications. For example, one or more low code development platforms can include Oracle Application Express (APEX), Oracle Visual Builder (VB), and/or any other suitable low code platform.

When implementing low code platforms, or many other software services, high levels of customization can be desirable. For example, end-users/customers can build web applications, or other suitable applications, using any number of combinations of components, functions, settings, and other variable elements of a low code platform. Accordingly, a widely used platform can present a large number of heterogenous environments with complex layers of components where a variety of errors, problems, inefficiencies, or general issues can be encountered. Developing an understanding of which issues are impactful across different customers/systems (or for specific customers/systems) can enable resources to be focused and prioritized (at times even before the errors are actually reported). Traditional implementations usually involve resources waiting for issue reports, and thus result in a lagging issue mitigation effort.

A technique for improving issue tracking systems is to enhance customer experience (less issue reporting) through recommendations based on prior issue logs for a support/development team. For example, these systems can passively track different sorts of customer impact behavior, such as issue count, issue types, similarity of issues, stack-trace types, and the like, in order to model potential customer impact. Unlike the more extensively researched explicit feedback, where issues are reported with certain kind of severity, passively tracked issues do not include direct input from the end users/customers regarding the issues. In particular, substantial past ticket history that indicates errors that have high severity for customers impacted is not available.

Embodiments identify unique properties of implicit issue log datasets. For example, log data can be gathered from various end user/customer specific systems. The log data can be processed with techniques to provide indications of high and low impact issues associated with varying confidence levels (e.g., using feature selection and importance). In some embodiments, a factor model can be used that is tailored for implicit recommenders.

A scalable optimization technique can also be implemented that scales linearly with data size. In some embodiments, the algorithm can be used successfully within a recommender system for a low code platform which aids in developing web applications (or other suitable applications). In addition, embodiments include a mechanism for providing explanations for recommendations given by this factor model. To achieve the prioritized list of issues, embodiments recommend a priority list of issues across customers (or for a specific customer), assisting support, developers, and quality assurance teams to understand what issues to prioritize without waiting for customers reporting.

Embodiments include a smart recommendation service that filters log data using different algorithms and recommends a prioritized list of issues (ranked 1, 2, 3 . . . ) as output. For example, past behavior of end users/customers impacted with issues can be captured, and based on these indications, issues can be ranked (e.g., based on an order of impact) using a hybrid approach of collaborative and content based mechanisms.

Embodiments of the issue recommendation service include a number of benefits:
Customer Satisfaction: Issues which have not been directly reported by end users/customers can be assessed by a product development/support team ahead of time. Based on a priority provided by the recommendation service, these unreported issues can be mitigated. Accordingly, going forward, end users/customers can report fewer issues which could impact operations.
Product Improvement: Issues that appear frequently and which are similar in nature, as prioritized by the recommendation service, can aid preventive solutions. For example, issues which are possible bugs (being un-noticed during testing & development phase) can be mitigated, which helps in improving the relevant product over a period of time.
Personalization: Recommendations are often received from end users/customers as part of feedback because they are a ripe source of issues/errors. For this reason, end users/customers are good at recommending issues, and recommendation systems often try to model this behavior. Embodiments of the recommendation service use the data accumulated indirectly to improve the product's overall services and ensure that they are suitable according to an end user/customer preference.
Reports: Providing a product team accurate and timely reporting enables effective decisions and prioritization of resources. Based on reports a product team can create a product roadmap and vision.

In the context of end users/customer systems impacted with issues, embodiments of the recommendation system use a hybrid approach of content based filtering and collaborative based filtering. For example, collaborative recommenders rely on data generated by interactions when end users/customers are impacted with issues. In the context of a smart service for issue recommendation, collaborative filters find trends in how similar customer systems (or operations/pods/module types of customer systems) are impacted by errors (e.g., what kind of errors and how many of them). The issue and issue count data can be decomposed or otherwise processed using a variety of techniques to ultimately find customer system and issue embeddings in a shared latent space. The issue embeddings, which describe their location in the latent space, can then be used to make issue-to-issue recommendations.

A benefit of collaborative data is that it is “self-generating”, meaning as end user/customer system data gets created issues are raised. This can be a valuable data source, especially in cases where high-quality issue features are not readily available or difficult to obtain. Another benefit of collaborative filters is that they can help discovery of new issues impacting customer systems that are outside the subspace defined by their historical profile. However, there are some drawbacks to collaborative filters, such as the cold start problem. It is also difficult for collaborative filters to accurately recommend novel or new issues because they typically do not have enough customer-issue interaction.

Content recommenders rely on issue features and similarity of issue to make recommendations. Examples of this include: Supplement Detail—Stack trace Details; Issue Class. Content filters tend to be more robust against popularity bias and the cold start problem. Thus, the content filters can be leveraged to recommend new or novel issues based on features extracted. However, in an issue-to-issue recommender, content filters can recommend issues with features similar to the original issue, which limits the scope of recommendations, and can also result in surfacing issuing with low severity.

Hence, in the context of embodiments of a service for a recommended list of prioritized issues, the collaborative filter techniques can resolve the question: “What issues have a similar customer impact?” and the content filter techniques can resolve the question: “What issues have similar features?” Because some embodiments implement a hybrid recommender using collaborative and content filtering, issues that impact other customer systems can be recommended/prioritized while still achieving on-topic recommendations based on the features of issues.

Returning to FIG. 1, data processing 102 can include functionality to process log data (e.g., raw log data) from one or more systems that implement an application (e.g., web application). For example, the application may be a low code platform with which an end user/customer interacts (to accomplish development of software), or any other suitable application. In some embodiments, the log data processed by data processing 102 can include logs generated by the low code platform (e.g., software and hardware that implements the platform) that indicate processes, timestamps, states, errors, issues, and other suitable log data for an executing application.

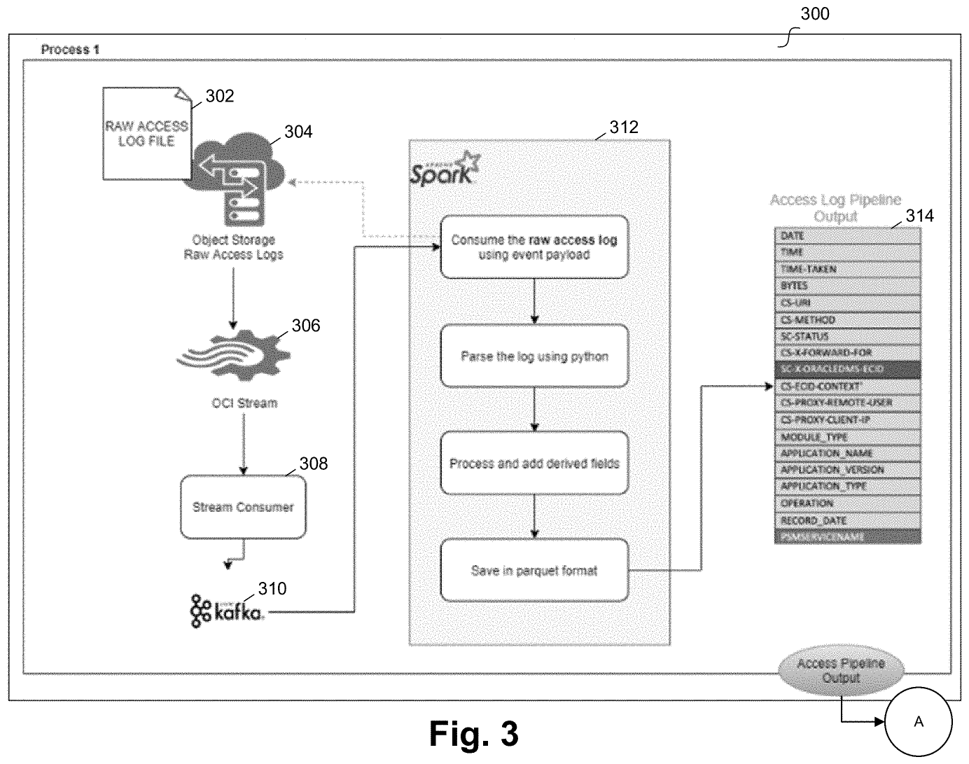

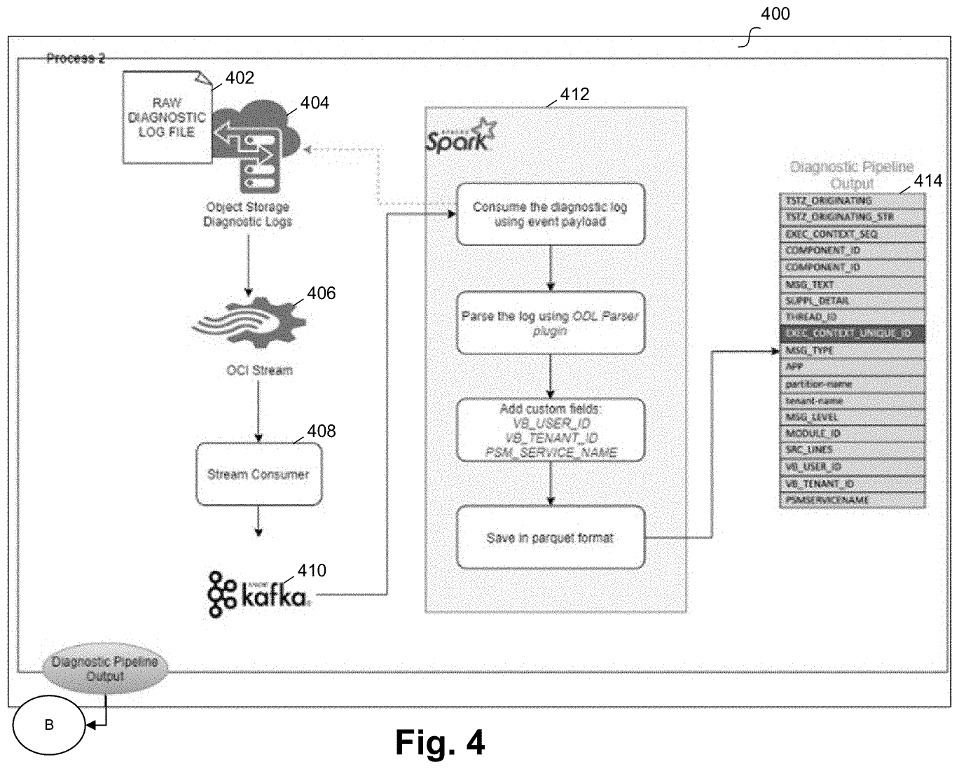

FIGS. 3-5 illustrate a system for processing data according to an example embodiment. For example, data processing 102 of FIG. 1 can include the functionality of FIGS. 3-5. System 300 of FIG. 3 illustrates the processing of raw access logs while system 400 of FIG. 4 illustrates the processing of raw diagnostic logs. System 500 illustrates the joining of these two logs to generate processed data that serves as input for the machine learning recommendation system. The Appendix includes examples of a raw access log file and a raw diagnostics log file.

In an embodiment, raw access log file 302 can be stored in object storage 304. Stream service 306, such as OCI Stream, can ingest a stream of access log files. Stream consumer 308 can consume the stream ingested by stream service 306. Streaming platform 310, such as an Apache Kafka cluster, can generate a data source pipeline, compiled stream, or otherwise generate a data source event stream. Stream processor 312 can process the data source event stream (e.g., raw access log files ingested to from a data source stream).

For example, the data source event stream can be consumed using the event payload (e.g., log file). The log can then be parsed (e.g., using a python script or any other suitable parser) and processed to add fields (e.g., derivative fields). The parsed and processed log can then be saved in a usable format (e.g., parquet format). Once processed, access log output 314 can be generated.

Similarly, in an embodiment raw diagnostic log file 402 of FIG. 4 can be stored in object storage 404. Stream service 406, such as OCI Stream, can ingest a stream of diagnostic log files. Stream consumer 408 can consume the stream ingested by stream service 406. Streaming platform 410, such as an Apache Kafka cluster, can generate a data source pipeline, compiled stream, or otherwise generate a data source event stream. Stream processor 412 can process the data source event stream (e.g., raw diagnostic log files ingested to from a data source stream).

For example, the data source event stream can be consumed using the event payload (e.g., log file). The log can then be parsed (e.g., using an ODL parser plugin or any other suitable parser) and processed to add fields (e.g., custom fields such as VB_USER_ID, VB_TENANT_ID, PSM_SERVICE_NAME, and the like). The parsed and processed log can then be saved in a usable format (e.g., parquet format). Once processed, diagnostic log output 414 can be generated.

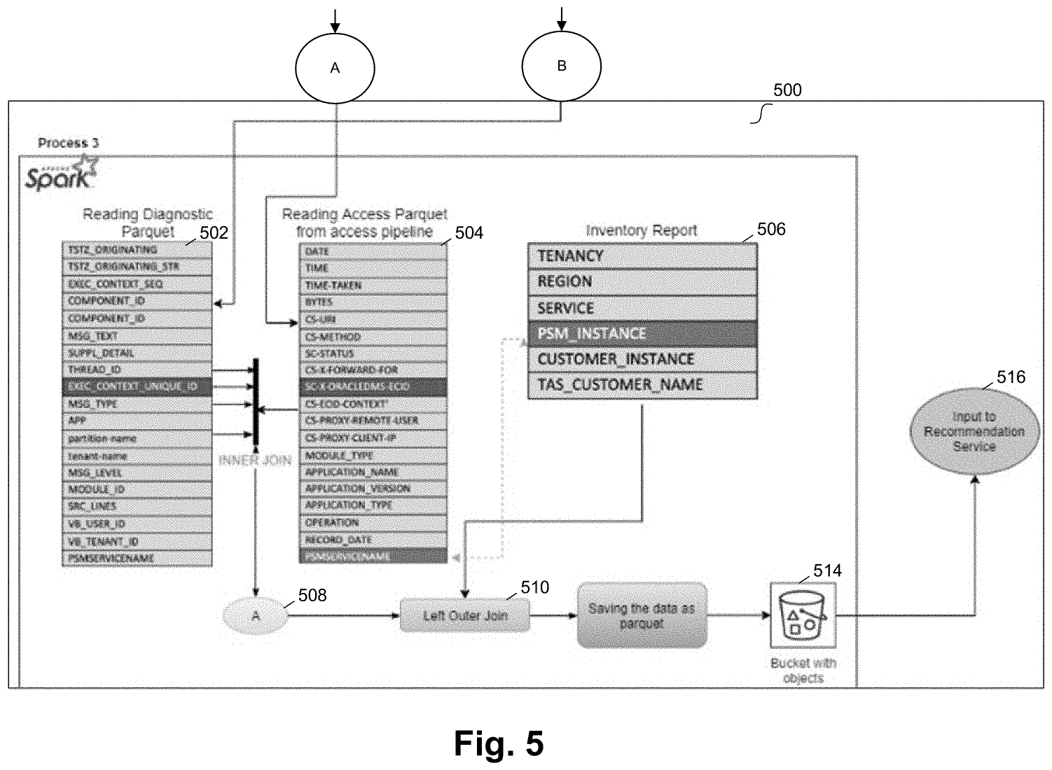

Referring to FIG. 5, access log output 314 (e.g., in parquet format) can be read to generate access log 502 and diagnostic log output 414 (e.g., in parquet format) can be read to generate diagnostic log 504. An inner-join of access log 502 and diagnostic log 504 can be used to generate first joined log 508. Further, a join (e.g., left outer join) can be used to join first joined log 508 with inventory data 506 to generate second joined log 510. Second joined log 510 can then be saved in a usable format (e.g., parquet format) and stored in bucket 514.

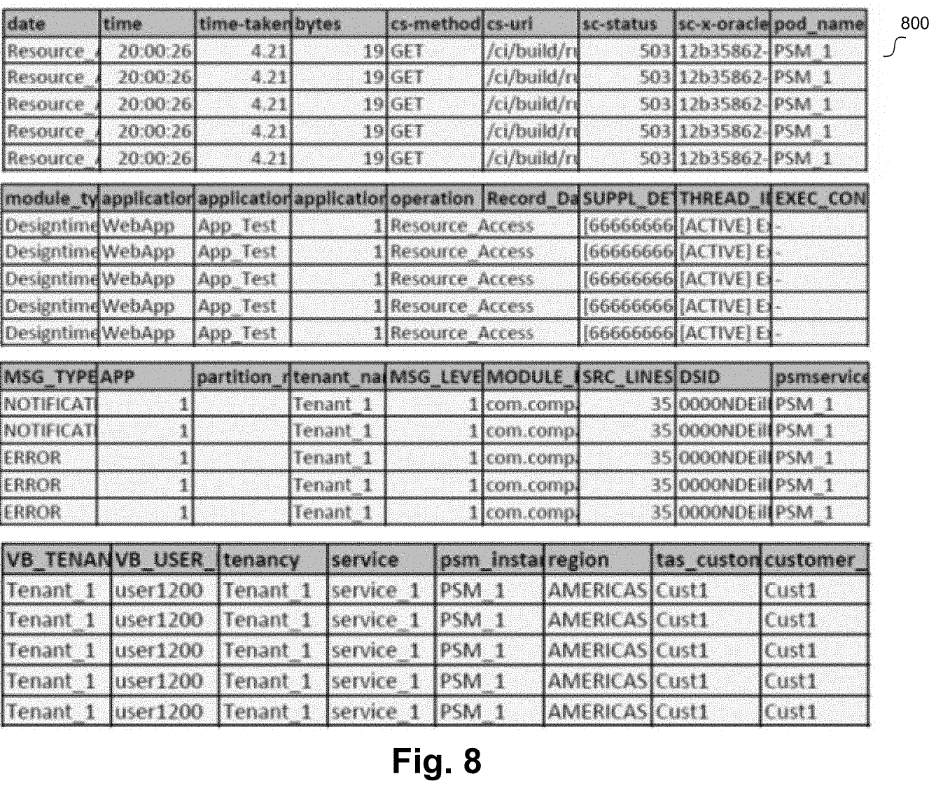

For example, the data stored in bucket 514 can represent processed versions of the access log and diagnostic log files (e.g., generated over time). In some embodiments, the raw log files (both access and diagnostic) are processed daily in a consumable format before they are fed to embodiments of the recommendation service. FIG. 8 illustrates sample processed data according to an example embodiment. For example, processed log 800 can represent data fields for a daily processed log generated by the functionality of FIGS. 3-5 and stored in bucket 514.

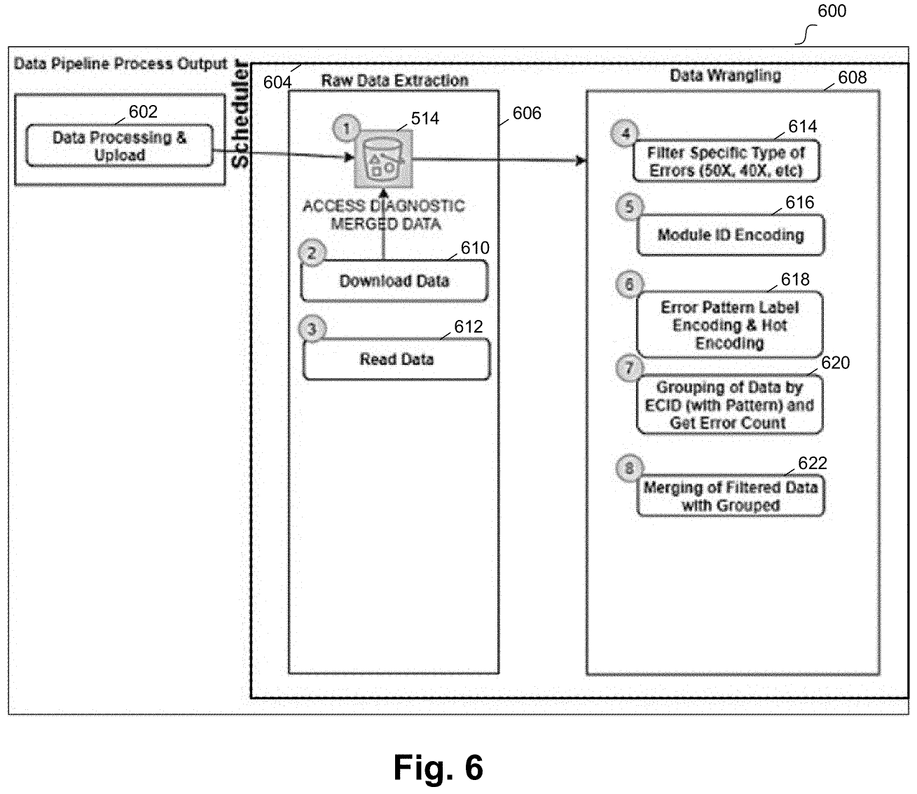

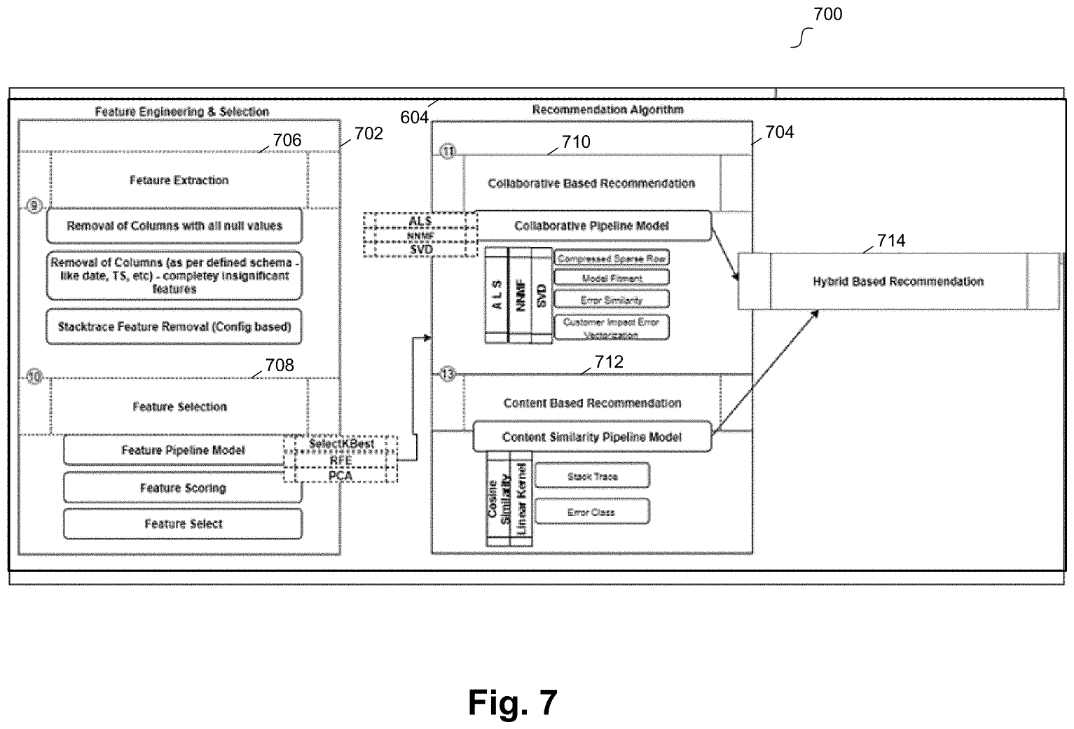

FIGS. 6-7 illustrate a data pipeline for generating issue recommendations according to an example embodiment. For example, processed log 800 can serve as input to embodiments of the pipelines 600 and 700 of FIGS. 6 and 7. For example scheduler 604 can include raw data extraction 606, data wrangling 608, feature engineering and selection 702, and recommendation algorithm 704. The output from scheduler 604 can be a hybrid recommendation 714.

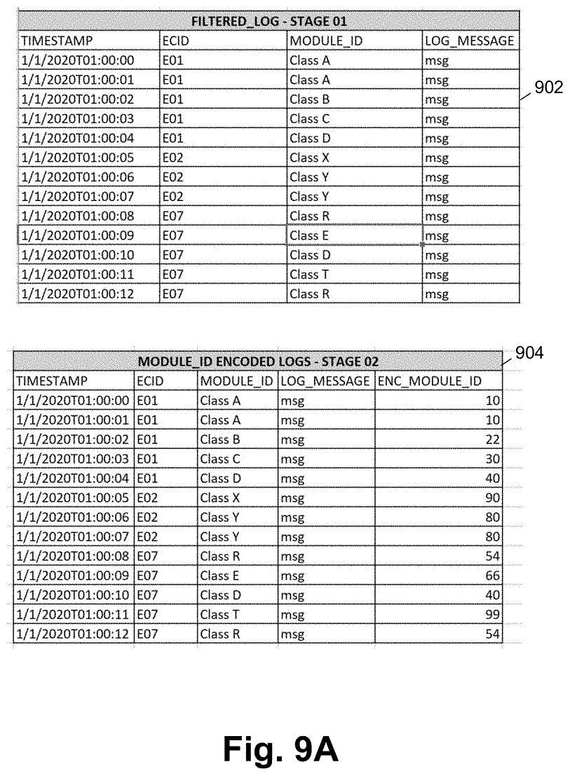

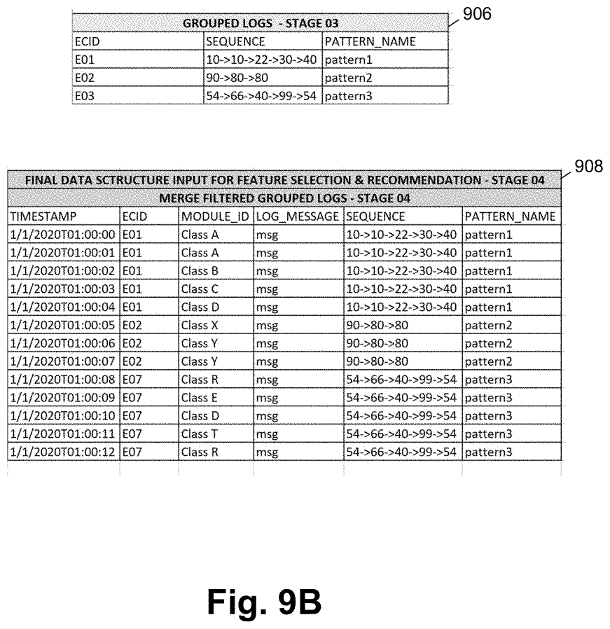

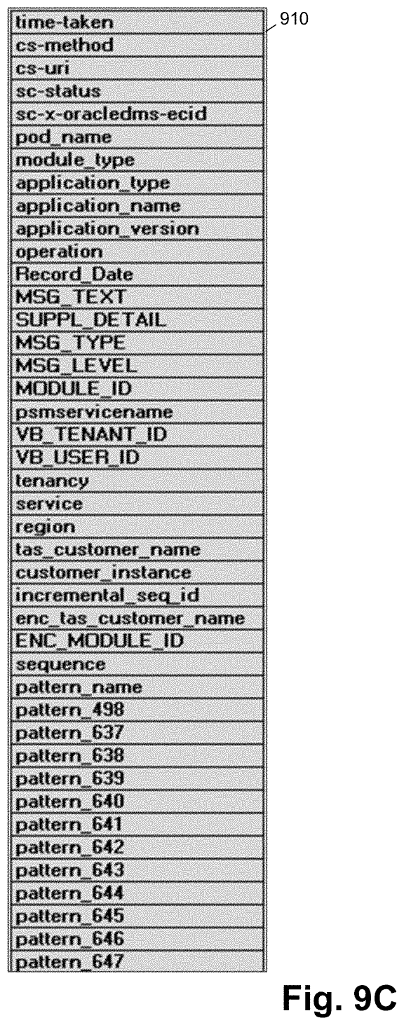

In some embodiments, data processing and loading 602, download data 610, and read data 612 can include the functionality of FIGS. 3-5. For example, bucket 514 can store processed logs over time. After raw data extraction 606, the processed logs stored in bucket 514 can be input to data wrangling 608. FIGS. 9A-9C illustrate output from data wrangling according to an example embodiment. For example, data 902, 904, 906, 908, and 910 can represent outputs at various stages of data wrangling 608. Filter type 614 of data wrangling 608 can filter the processed logs based on issue type. For example, an issue can be an error in some embodiments, and the errors in the processed logs can be filtered by error type (e.g., 5XX, 40X, and the like).

In some embodiments, the log data can be generated by a system configuration implementing a low code platform. For example, the low code platform can generate Hypertext Transfer Protocol (“HTTP”) client side errors, such as 40X (e.g., 400, 401, 403, and the like) which indicate bad requests, unauthorized errors, forbidden errors, and the like, and HTTP server side errors such as 5XX (e.g., 500, 502, 504, and the like) which indicate internal server errors, bad gateway, gateway timeout, and the like. In some embodiments, the recommendation system filters for specific error types (filtering out other error types) and the filtering can be configured. For example, the recommendation system can filter for one or many of the HTTP errors.

In some embodiments, filter type 614 can perform other types of filtering. For example, columns with a value of “NA”, “null”, or the like can be removed or dropped (e.g., for all or a subset of rows for that column). In another example, rows with certain values in predefined columns can be dropped, such as dropping rows that have “NA” or “null” values in a customer column or a value that indicates an internal customer. Data 902 of FIG. 9A illustrates sample output from filter type 614. Other or substitute filtering functionality can be similarly implemented.

After filtering, distinct attributes of the logs can be identified and used at encoding 616 to encode numeric values for the machine learning algorithms to further process. For example, attributes like module ID can indicate a class or logger system for a log entry, and one or more of these attributes can be used individually or merged with other attributes to generate distinct numeric IDs. In some embodiments, these distinct numeric IDs can further be used to define a sequence or pattern (e.g., based on the timestamp of the logs). Data 904 of FIG. 9A illustrates sample output from encoding 616. Other or substitute encoding functionality can be similarly implemented.

After encoding 616, pattern label encoding 618 can encode an issue pattern label for issues or errors. For example, a pattern label can be generated for a sequence that defines the pattern as an issue or error. Pattern label encoding can implement a one hot encoding for the pattern label. In some embodiments, the pattern label can be an error code ID (“ECID”) field, and each row of processed log data can include an ECID field and an encoded numeric ID field. For example, the value of ECID field can be consistent across multiple rows for different encoded numeric ID values. The sequence of the encoded numeric ID values across multiple rows for the same ECID value can indicate a sequence of log entries (e.g., sequence of classes or composite of attributes that comprise the encoded numeric IDs), and thus define a distinct pattern of issue or error.

In some embodiments, after pattern label encoding 618, grouping 620 can group the data. For example, the data (e.g., data rows) can be grouped by ECID to generate a sequence and define a distinct error. Embodiments utilize ECID as a unique identifier that can be used to correlate individual events (e.g., log entries) as being part of the same execution flow (e.g., request execution flow, such as an HTTP request or reply). For example, events that are identified as being related to a particular request typically have the same ECID value.

In some embodiments, when the log data comprising the events of a request is processed in the system, each log line can be augmented with the ECID value which allows for the identification of logs that were generated for a specific request. For example, rows can be grouped based on their ECID, and once grouped the encoded numeric ID values can be used to derive the sequence. In some embodiments, each sequence can then be assigned a pattern name and it can be one hot encoded. Data 906 of FIG. 9B illustrates sample output from pattern label encoding 618 and grouping 620. Other or substitute encoding and grouping functionality can be similarly implemented.

In some embodiments, the derived pattern and sequence attributes can then be merged back to the filtered data at merging 622. For example, based on the ECID that already exists (for each row based on pattern label encoding 618), the data pattern and sequence attributes can be merged back into the processed log data. Data 910 of FIG. 9C illustrates the fields for the data output after merging 622 (and after data wrangling 608). For example, this output from data wrangling 608 can be provided to feature engineering and selection 702 of FIG. 7.

In some embodiments, feature engineering and selection 702 can perform both feature extraction 706 and feature selection 708. Feature extraction 706 can include column removals. For example, columns with null values can be removed (if it not already removed during data wrangling) and removal of columns that are determined to be insignificant, such as insignificant for a given defined schema (e.g., date, timestamp, and the like). Some embodiments of feature extraction 706 can include removal of portions of stacktrace data present in a log based on configuration. For example, stop words can be being removed using an n-gram methodology to vectorize the data.

After feature extraction 706, feature selection 708 can select relevant features for the recommendation algorithms. Feature selection 708 can include a feature pipeline model, feature scoring, and ultimately feature selection. Feature selection 708 can aid in selecting columns/attributes that impact an issue or error pattern (multi-label variable). These features/attributes can become weights for how each customer/issue relates to each feature.

For example, the feature pipeline model functionality can include selection of the K best features, recurrent feature elimination (“RFE”), and principal component analysis (“PCA”). Example inputs to feature engineering and selection 702 can be the output from data wrangling 608 of FIG. 6 (e.g., data 910 of FIG. 9C) and a feature. An Example output from feature engineering and selection 702 can be the following:

tas_customer_name
pattern_name
<FEATURE>

In many implementations, a single customer can be impacted with multiple issues or errors (e.g., errors defined using a distinct sequence of encoded class/module-IDs). Embodiments that predict issues or errors (e.g., what customer can be impacted with what errors), can aim to solve a multi-label classification problem. To address multi-classification problems, machine learning algorithms can learn trends in log data that contribute to the prediction an error variable. Having too many irrelevant features in the data can decrease accuracy of the models, and thus the features that are used for learning are particularly impactful. This automated technique for identifying features (e.g., variable selection) is called feature selection—aiding to identify and remove unneeded, irrelevant, and redundant attributes from log data that do not provide meaningful contributions to error prediction and recommendation.

In some embodiments, a feature selection pipeline provides one or more algorithms, such as SelectKBest, recursive feature elimination, and/or principal component analysis, specifically to address the multi-label classification problem. In some embodiments, the feature being analyzed using the algorithms above, based on the score, is the error frequency, hence this feature is used as a weight for collaborative recommendation.

After feature engineering and selection 702, recommendation algorithms 704 can be used to generate recommended issues. For example, recommendation algorithm 704 can include collaborative based recommendation 710 and content based recommendation 712. In some embodiments, collaborative based recommendation 704 can include a collaborative pipeline model. For example, the collaborative pipeline model can include alternative least squares (“ALS”) matrix factorization, non-negative (“NMF”) matrix factorization, and/or singular value decomposition (“SVD”). Collaborative based recommendation 710 can be achieved using a compressed sparse row, model fitting, and error similarity. A customer impact issue vectorization can be generated.

In some embodiments, latent or hidden features can be learned using matrix decomposition and a sparse matrix. Example matrices include:

### Matrix 1:

[[−1.64103806e-02 −8.79750252e-02 1.16341218e-01 9.86066684e-02 −8.25168043e-02] [4.90291454e-02 −2.23248154e-02 1.73840579e-02 1.10682495e-01 3.64041259e-03] [6.88640922e-02 −4.15053107e-02 −1.09405480e-02 −6.02287613e-02 8.80124643e-02] [−1.38925277e-02 4.85707447e-02 1.30442372e-02 3.61302011e-02 7.27838501e-02] [4.93109412e-02 −2.24461779e-02 1.74841564e-02 1.11312300e-01 3.66748753e-03] [4.92898077e-02 −2.24430207e-02 1.74756404e-02 1.11269921e-01 3.65988654e-03] [−1.77272689e-02 −9.50304419e-02 1.25668749e-01 1.06513351e-01 −8.91320184e-02] [−1.39434999e-02 4.87498604e-02 1.30919572e-02 3.62632722e-02 7.30522275e-02] [3.57821509e-02 3.57510298e-02 3.16088647e-02 −1.29697388e-02 −1.60857607e-02] [−1.40356636e-02 4.90469672e-02 1.30487252e-02 3.61330621e-02 7.32733980e-02] [−1.03861457e-02 8.42446834e-02 −8.76615271e-02 2.28500981e-02 −2.67089326e-02] [−8.84269997e-02 −8.55356979e-04 1.02966636e-01 −1.57209171e-04 3.80954077e-03] [3.57822552e-02 3.57508957e-02 3.16088945e-02 −1.29696885e-02 −1.60858054e-02] [−1.04373628e-02 8.46566632e-02 −8.80883038e-02 2.29420252e-02 −2.68312152e-02] [−1.30566120e-01 1.17883191e-01 1.82738733e-02 −1.27578706e-01 1.09267622e-01] [6.87290728e-02 −4.14232202e-02 −1.09194862e-02 −6.01117276e-02 8.78403112e-02] [−8.33434425e-03 −1.26290560e-01 1.59744099e-01 1.12915754e-01 −7.60364830e-02] [−8.83023515e-02 −8.54091370e-04 1.02821678e-01 −1.57151459e-04 3.80429206e-03] [−8.84271562e-02 −8.55375605e-04 1.02966838e-01 −1.57220085e-04 3.80955008e-03] [1.02549218e-01 −3.15557495e-02 −2.56615020e-02 −3.87456939e-02 1.38433799e-01]]

### Matrix 2:

[[3.8206112 −3.3523235 0.5352928 −3.1464224 4.649648 ] [8.981722 8.953763 7.9296594 −3.2786942 −4.061797 ] [−0.9369624 5.138918 −4.7808857 2.9353266 −2.4254053 ] [−4.9193196 0.5293021 5.364358 −0.54126215 1.2001945 ] [−2.5192251 1.8095746 1.0579945 −1.7090294 1.8590521 ] [−0.05286982 −2.2611058 2.8091924 1.5266917 −0.84964484] [−2.5399213 1.824448 1.0666889 −1.723072 1.8743249 ] [3.0863929 −1.4685172 0.12518607 −0.61335856 4.325002] [3.1411793 0.23709063 0.2937519 7.5108275 2.0096679 ] [−1.2055302 4.757909 1.8512049 5.2826858 7.295933 ] [−0.43914708 −2.0187466 2.6778288 2.0572307 −1.846136]]

Embodiments include an original matrix X of size C×E, with customers, errors, and error frequency data (deduced from frequency selection). The above two matrices (Matrix 1 & Matrix 2) are created by a sparsing mechanism from the original matrix X in order to transform X into one matrix with customers and hidden features of size C×F and one matrix with errors and hidden features of size F×E. Accordingly, Matrix1 and Matrix2 include weights for how each customer/error relates to each feature. Embodiments can calculate Matrix1 and Matrix2 so that their product approximates X as closely as possible: X≈Matrix1×Matrix2.

In some embodiments, model training based on the sparse matrix can utilize one or more matrix factorization algorithms (e.g., ALS, NMF, SVD). For example, by randomly assigning the values in Matrix1 and Matrix2 and using least squares iteratively, the weights can be improved until they yield an optimal approximation of original matrix X. The least squares approach includes fitting some line to the data, measuring the sum of squared distances from all points to the line, and achieving an optimal fit by minimizing this value. With the alternating least squares approach the same idea is used but the technique iteratively alternates between optimizing U (or Matrix 1) and fixing V (or Matrix 2) and vice versa (optimizing V and fixing U). For example, this can be performed for each iteration to arrive closer to X≈Matrix1×Matrix2. Hence, ALS is an iterative optimization process where each iteration is configured to increase accuracy of a factorized representation of our original data.

In some embodiments, preference (p) and confidence (c) values for an issue or error can also be used. An example model solution is to merge a preference (p) for an issue or error with a confidence (c) for that preference. In some embodiments, the preference and confidence values for an issue or error relate to customer feedback about the issue or error. For example, missing values (e.g., unknown customer impact) can be initiated with a negative preference and a low confidence value and existing values (e.g., known customer impact) can have a positive preference with a high confidence value. In other words, the preference can be a binary representation of issue or error frequency data (e.g., negative or positive, zero or one, and the like). If user/customer feedback received about an issue or error is greater than zero, the preference can be set to 1.

In some embodiments, the confidence can be calculated using the magnitude of the error frequency data (e.g., absolute value when error frequency is a real number), which can provide a more distilled confidence value than a binary representation. The rate at which confidence increases (e.g., increases as a function of issue or error frequency) can be set through a linear scaling factor, or through other suitable techniques. In some embodiments, a value (e.g., 1) can be added to ensure a minimal confidence even if (linear scaling factor x error frequency) is zero. In these embodiments, even if little impact between a customer and error exists, the confidence will be higher than that of the unknown data (no impacted customers).

In some embodiments, a score can be derived using the results of the model training and/or preference and confidence values. For example, the score can be based on the confidence and preference of the two matrices:

$${min}_{x , y} {\sum }_{c , e} {{c}_{c e} ( {p}_{c e} - {x}_{c}^{T} {y}_{e} )}^{2} + λ ( {\sum }_{c} {‖ {x}_{c} ‖}^{2} + {\sum }_{e} {‖ {y}_{e} ‖}^{2} )$$

where c_{ce} is the confidence of the preference, x_{c} is latent vector representing customer, and yₑ is latent vector representing error. For example, a dot product x_{c}^{T}yₑ that is close to the binary indicator of preference p_{ce} indicates an issue or error for recommendation. In other words, the closer the dot product x_{c}^{T}yₑ is to one, the more likely the error is recommended, and the closer to zero the less likely the issue or error is recommended. By finding optimal parameters, these values would be pushed arbitrary close to zero or one, but by introducing the confidence and regularization factors λ and

$${\sum }_{c} {‖ {x}_{c} ‖}^{2} + {\sum }_{e} {‖ {y}_{e} ‖}^{2} ,$$

the optimization achieves improved results.

In some embodiments, after optimization of the customer latent vector representation (x_{c}) and the error latent vector representation (yₑ), such as by ALS, the scores for issue or error and customer pairs can be given by x_{c}^{T}yₑ. In other words, columns-row values of x_{c}^{T}yₑ can provide corresponding preference/recommendation scores for specific pairs of issue or error and customer. In some embodiments, the scores for a given customer can be extracted and ranked (e.g., highest value to lowest value).

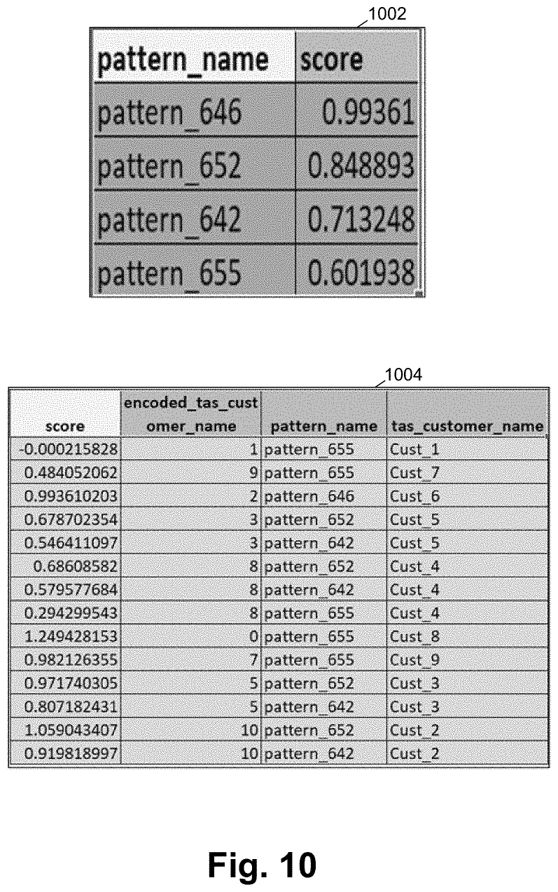

The result can indicate an issue ranking based on a weighted average score, which customer systems were impacted with these issues, and which customer systems may be impacted by these issues in the future. FIG. 10 illustrates issue recommendation output according to an example embodiment. For example, collaborative based recommendation 710 can generate output 1002 and output 1004.

In some embodiments, content based recommendation 712 can also generate recommendations. For example, content based recommendation 712 can include a content similarity pipeline model. The content similarity pipeline model can include a similarity metric (e.g., cosine similarity) and/or a kernel (e.g., linear kernel). The dot product between two vectors (when the text/characters are vectorized) is equal to the projection of one of them on the other. Therefore, the dot product between two identical vectors (i.e. with identical components) is equal to their squared module, while if the two are perpendicular (i.e. they do not share any directions), the dot product is zero.

Example output of the data wrangling 608 can be fed to embodiments of content based recommendation 712, including supplement details (message stack trace) and pattern name. Content based recommendation 712 can be achieved by processing a stack trace for issues and issue class (e.g., error class). Similarity using the message stack trace for an issue/error pattern can be based on a linear kernel, cosine similarity, TFidVectorizer, and any other suitable similarity metric or algorithm. This score represents the similarity of the content, based on the text similarity.

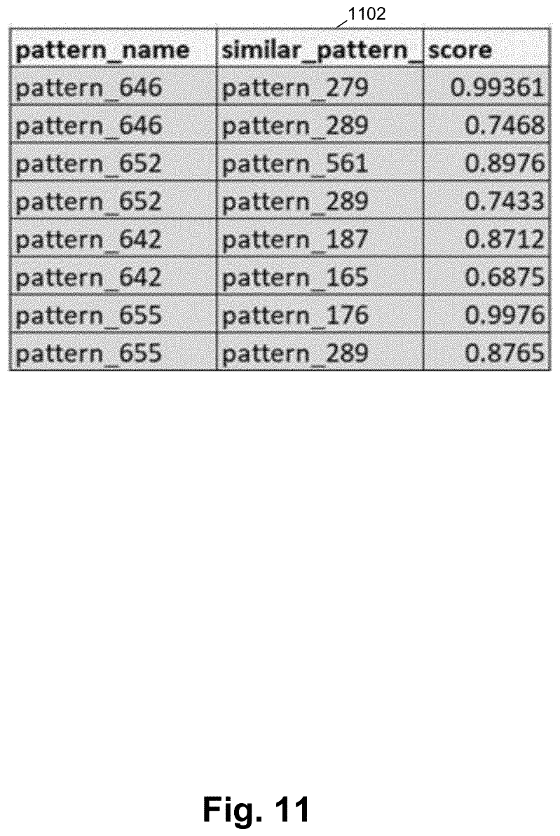

The result can indicate an issue ranking based on a weighted average score, and which issues are similar. FIG. 11 illustrates issue recommendation output according to an example embodiment. For example, content based recommendation 712 can generate output 1102.

In some embodiments, hybrid based recommendation 714 can be a combination of recommendations generated from collaborative based recommendation 710 and content based recommendation 712. For example, the outputs of collaborative based recommendation 710 and content based recommendation 712 can be joined (e.g., using pattern_name) to generate a combined data structure. An average of the scores can be taken and a threshold number (e.g., 5, 10, 15, 20, and the like) of highest scored (or lowed scored) issues can be recommended. By using an ensemble of collaborative and content-based learning, recommendations that draw from the strengths of both techniques can be generated.

Hybrid based recommendation 714 enables embodiments to fetch existing customers impacted by issues as well as future possible customers (e.g., based the priority list of issues and their linkage with pattern_name and collaborative dataset for future impact customer names). Hybrid based recommendation 714 can prioritize/recommend issues based on a highest score, and the issues can be either existing issues or issues similar to existing issues.

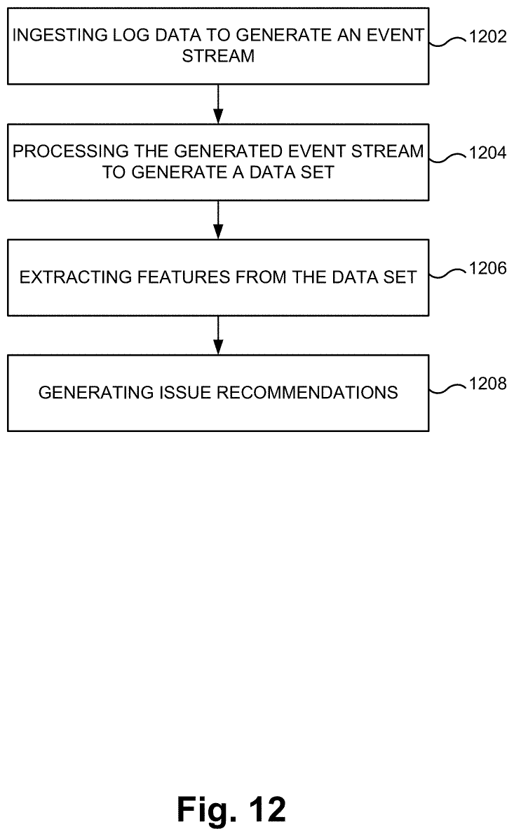

FIG. 12 illustrates a flow diagram for generating machine learning predictions using log data according to an example embodiment. In one embodiment, the functionality of FIG. 12 is implemented by software stored in memory or other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software.

At 1202, log data can be ingested to generate an event stream for a plurality of systems, where each of the plurality of systems can be a combination of components, and the plurality of systems present heterogenous system architectures. For example, system implementations can include combinations of cloud services, combinations of platform configurations, or other suitable combinations of components that present a system architecture. In some embodiments, the plurality of systems include different combinations of components that present unique heterogeneous system architectures. For example, the heterogenous system architectures can be different mixes of individual components. In some embodiments, a portion of the heterogenous system architectures can be independent systems that are hosted in different cloud environments for different cloud customers.

In some embodiments, the software and hardware the implement the plurality of systems generate log data. The log data can be ingested, such as by a streaming service or platform, to generate an event stream. In some embodiments, the log data can include an access log and a diagnostic log.

At 1204, the generated event streams can be processed to generate a data set, where the data set includes issue labels for issues experienced by the plurality of systems. For example, while the systems are executing software, errors, inefficiencies, or general issues can be encountered that are reflected in the log data. The generated event streams can be processed to generate a data set that includes labels for issues experienced by these systems.

In some embodiments, each issue label can be defined based on a distinct sequence of log data from the event streams, the distinct sequences being representative of the issue labels. For example, module IDs associated with the components that comprise the plurality of cloud systems can be determined from the log data, and processing the generated event streams to generate the data set can include encoding the log data from the event streams with the module IDs. In some embodiments, the distinct sequences of log data are defined using distinct sequences of module IDs.

At 1206, features can be extracted from the generated data set. For example, the feature extraction can include a feature pipeline model that selects the K best features, implements recurrent feature elimination (“RFE”), and/or implements principal component analysis (“PCA”).

At 1208, issue recommendations can be generated using a plurality of machine learning algorithms based on the extracted features and the generated data set, where the issue recommendations can be generated using a hybrid of collaborative based machine learning filtering and content based machine learning filtering. For example, the collaborative based machine learning filtering can generate a first recommendation score for the issue labels in the data set, the first recommendation score being based on issue embeddings defined in a shared latent space. In some embodiments, the shared latent space can be a latent space that maps at least a portion of the heterogeneous system architectures to a weight set and at least a portion of the issue labels to the weight set.

In another example, the content based machine learning filtering can generate a second recommendation score for the issue labels in the data set, the second recommendation score being based on a similarity between issue parameters for at least two issue labels. In some embodiments, the issue parameters can be a stack trace for one or more errors related to the at least two issue labels.

In some embodiments, the issue recommendations can be generated using a combination of the first recommendation score and the second recommendation score. For example, the scores can be combined by taking an average, a weighted average, or any other arithmetic function of the scores.

Embodiments generate machine learning recommendations using log data according to an example embodiment. A cloud service provider can implement a number of different system architectures, such as for different end users or customers. For example, system implementations can include combinations of cloud services, combinations of platform configurations, or other suitable combinations of components that present a system architecture. In some embodiments, the plurality of systems include different combinations of components that present unique heterogeneous system architectures.

Accordingly, a given cloud service provider with a number of customers/systems can result in a large number of heterogenous environments with complex layers of components, where a variety of errors, problems, inefficiencies, or general issues can be encountered. Developing an understanding of which issues are impactful across different customers/systems (or for specific customers/systems) can enable resources to be focused and prioritized (at times even before the errors are actually reported). In some embodiments, the software and hardware the implement the plurality of systems generate log data. For example, each system (with a given system architecture) can generate log data over time. In addition, while the systems are executing software, errors, inefficiencies, or general issues can be encountered that are reflected in the log data.

In some embodiments, this log data is processed to generate a data set for machine learning. The generated data set can include issue labels, or labels for a sequence of log data/entries that represent an issue encountered when implementing the systems. In addition, features can be extracted from the data set that reflect characteristics of the issue labels. In some embodiments, issue recommendations can be generated using machine learning algorithms based on the extracted features and the generated data set. For example, collaborative based machine learning filtering and content based machine learning filtering can be used to generate a hybrid recommendation of issues. In some embodiments, the hybrid recommendation of issues can represent errors that impact across different ones of the system architectures and/or errors that are impactful to the systems.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

APPENDIX
Access Raw Log File

| | |
|---|---|
| 2020-07-14 | 20:00:26 4.21 19 GET |

/ci/build/running/notoptimized/live/resources/data/access?onlyData=true;

| | |
|---|---|
| 503 | “12b35862-8dd5-443e-88fa-d23639864955-00005b75” |

APPENDIX
Diagnostic Raw Log File

[2020-07-
14T20:00:24.436+00:00][server_1][NOTIFICATION][ ][com.company.test.ramp.service.P
roxy][tid:[ACTIVE].ExecuteThread:‘110’forqueue:‘appserver.kernel.Default(self-
tuning)’][userId:user1200][ecid:12b35862-8dd5-443e-88fa-d23639864955-
00005b75,0][APP:testBundle][partition-name:DOMAIN][tenant-
name:GLOBAL][DSID:0000NDEiIEG6YNAin_WvkJ1V3V_300008_][6666666666666666
6666666666666666][77777777777777777777777777777777][66666666666666666666
666666666666][77777777777777777777777777777777][666666666666666666666666
66666666][77777777777777777777777777777777][6666666666666666666666666666
6666][77777777777777777777777777777777]GET/ci/build/running/notoptimized/live/re
sources/data/accessBugsettingtimeoutof60s[2020-07-
14T20:00:24.436+00:00][server_1][NOTIFICATION][ ][com.company.test.ramp.service.P
roxy][tid:[ACTIVE].ExecuteThread:‘110’forqueue:‘appserver.kernel.Default(self-
tuning)’][userId:user1200][ecid:12b35862-8dd5-443e-88fa-d23639864955-
00005b75,0][APP:testBundle][partition-name:DOMAIN][tenant-
name:GLOBAL][DSID:0000NDEiIEG6YNAin_WvkJ1V3V_300008_][6666666666666666
6666666666666666][77777777777777777777777777777777][66666666666666666666
666666666666][77777777777777777777777777777777][666666666666666666666666
66666666][77777777777777777777777777777777][6666666666666666666666666666
6666][77777777777777777777777777777777]GET/ci/build/running/notoptimized/live/re
sources/data/accessBugsettingtimeoutof60s[2020-07-
14T20:00:24.909+00:00][server_1][ERROR][ ][com.company.test.ramp.service.Proxy][tid
:[ACTIVE].ExecuteThread:‘110’forqueue:‘appserver.kernel.Default(self-
tuning)’][userId:user1200][ecid:12b35862-8dd5-443e-88fa-d23639864955-
00005b75,0][APP:testBundle][partition-name:DOMAIN][tenant-
name:GLOBAL][DSID:0000NDEiIEG6YNAin_WvkJ1V3V_300008_][6666666666666666
6666666666666666][77777777777777777777777777777777][66666666666666666666
666666666666][77777777777777777777777777777777][666666666666666666666666
66666666][77777777777777777777777777777777][6666666666666666666666666666
6666][77777777777777777777777777777777]Proxyfailedtothreadwork[[java.util.concur
rent.RejectedExecutionException:Taskcom.company.test.tenant.TenantExecutorServic
e$$Lambda$225/2022185405@24ef9b00rejectedfromcom.company.test.tenant.Tenant
ExecutorService$1@596e810d[Running,poolsize=40,activethreads=40,queuedtasks=1
00,completedtasks=11215]

atjava.util.concurrent.ThreadPoolExecutor$AbortPolicy.rejectedExecution(Thr

eadPoolExecutor.java:2063)

atjava.util.concurrent.ThreadPoolExecutor.reject(ThreadPoolExecutor.java:83

0)

atjava.util.concurrent.ThreadPoolExecutor.execute(ThreadPoolExecutor.java:

1379)

atcom.company.test.tenant.TenantExecutorService$1.execute(TenantExecut

orService.java:121)

| | |
|---|---|
| | atjava.util.concurrent.AbstractExecutorService.submit(AbstractExecutorServic |
| e.java:134) | atcom.company.test.ramp.service.Proxy.proxy(Proxy.java:273) |
| | atsun.reflect.GeneratedMethodAccessor1828.invoke(UnknownSource) |
| | atsun.reflect.DelegatingMethodAccessorImpI.invoke(DelegatingMethodAcces |
| sorImpI.java:43) | atjava.lang.reflect.Method.invoke(Method.java:498) |
| | atorg.opensource.jersey.server.model.internal.ResourceMethodInvocationHa |

ndlerFactory$1.invoke(ResourceMethodInvocationHandlerFactory.java:81)

atorg.opensource.jersey.server.model.internal.AbstractJavaResourceMethod

Dispatcher$1.run(AbstractJavaResourceMethodDispatcher.java:144)

atorg.opensource.jersey.server.model.internal.AbstractJavaResourceMethod

Dispatcher.invoke(AbstractJavaResourceMethodDispatcher.java:161)

atorg.opensource.jersey.server.model.internal.JavaResourceMethodDispatch

erProvider$ResponseOutInvoker.doDispatch(JavaResourceMethodDispatcherProvider.j
ava:160)

atorg.opensource.jersey.server.model.internal.AbstractJavaResourceMethod

Dispatcher.dispatch(AbstractJavaResourceMethodDispatcher.java:99)

atorg.opensource.jersey.server.model.ResourceMethodInvoker.invoke(Resou

rceMethodInvoker.java:389)

atorg.opensource.jersey.server.model.ResourceMethodInvoker.apply(Resour

ceMethodInvoker.java:347)

atorg.opensource.jersey.server.model.ResourceMethodInvoker.apply(Resour

ceMethodInvoker.java:102)

| | |
|---|---|
| | atorg.opensource.jersey.server.ServerRuntime$2.run(ServerRuntime.java:32 |
| 6) | atorg.opensource.jersey.internal.Errors$1.call(Errors.java:271) |
| | atorg.opensource.jersey.internal.Errors$1.call(Errors.java:267) |
| | atorg.opensource.jersey.internal.Errors.process(Errors.java:315) |
| | atorg.opensource.jersey.internal.Errors.process(Errors.java:297) |
| | atorg.opensource.jersey.internal.Errors.process(Errors.java:267) |
| | atorg.opensource.jersey.process.internal.RequestScope.runInScope(Request |

Scope.java:317)

atorg.opensource.jersey.server.ServerRuntime.process(ServerRuntime.java:3

05)

atorg.opensource.jersey.server.ApplicationHandler.handle(ApplicationHandler

.java: 1154)

atorg.opensource.jersey.servlet.WebComponent.serviceImpI(WebComponent

.java:471)

atorg.opensource.jersey.servlet.WebComponent.service(WebComponent.jav

a:425)

atorg.opensource.jersey.servlet.ServletContainer.service(ServletContainer.jav

a:383)

atorg.opensource.jersey.servlet.ServletContainer.service(ServletContainer.jav

a:336)

atorg.opensource.jersey.servlet.ServletContainer.service(ServletContainer.jav

a:223)

atappserver.servlet.internal.StubSecurityHelper$ServletServiceAction.run(Stu

bSecurityHelper.java:286)

atappserver.servlet.internal.StubSecurityHelper$ServletServiceAction.run(Stu

bSecurityHelper.java:260)

atappserver.servlet.internal.StubSecurityHelper.invokeServlet(StubSecurityH

elper.java:137)

| | |
|---|---|
| | atappserver.servlet.internal.ServletStubImpI.execute(ServletStubImpI.java:35 |
| 0) | atappserver.servlet.internal.TailFilter.doFilter(TailFilter.java:25) |
| | atappserver.servlet.internal.FilterChainImpI.doFilter(FilterChainImpI.java:78) |
| | atappserver.security.internal.IDCSSessionSynchronizationFilter.doFilter(IDCS |

SessionSynchronizationFilter.java:176)

| | |
|---|---|
| | atappserver.servlet.internal.FilterChainImpI.doFilter(FilterChainImpI.java:78) |
| | atappserver.websocket.tyrus.TyrusServletFilter.doFilter(TyrusServletFilter.jav |
| a:274) | atappserver.servlet.internal.FilterChainImpI.doFilter(FilterChainImpI.java:78) |
| | atcom.company.test.metrics.RtVisitorTrackingFilter.doFilter(RtVisitorTracking |

Filter.java:250)

atappserver.servlet.internal.FilterChainImpI.doFilter(FilterChainImpI.java:78)
atcom.company.test.rt.ApplicationReleaseFilter.doFilterChain(ApplicationRele

aseFilter.java:651)

atcom.company.test.rt.ApplicationReleaseFilter.doFilter(ApplicationReleaseFil

ter.java:241)

atappserver.servlet.internal.FilterChainImpI.doFilter(FilterChainImpI.java:78)
atcom.company.test.rs.servlet.ExceptionCatchFilter.doFilter(ExceptionCatchF

ilter.java:102)

atappserver.servlet.internal.FilterChainImpI.doFilter(FilterChainImpI.java:78)
atcom.company.test.authorization.CSRFFilter.doFilter(CSRFFilter.java:120)
atappserver.servlet.internal.FilterChainImpI.doFilter(FilterChainImpI.java:78)
atcom.company.test.service.SlashSlashWarningFilter.doFilter(SlashSlashWar

ningFilter.java:54)

atappserver.servlet.internal.FilterChainImpI.doFilter(FilterChainImpI.java:78)
atcom.company.test.authorization.CORSFilter$SameOriginCorsFilterImpI.doF

ilter(CORSFilter.java:482)

atcom.company.test.authorization.CORSFilter.doFilter(CORSFilter.java:131)
atappserver.servlet.internal.FilterChainImpI.doFilter(FilterChainImpI.java:78)
atcom.company.test.metrics.DtVisitorTrackingFilter.doFilter(DtVisitorTracking

Filter.java:253)

atappserver.servlet.internal.FilterChainImpI.doFilter(FilterChainImpI.java:78)
atcom.company.test.authorization.TenantFilter.doFilter(TenantFilter.java:210)
atappserver.servlet.internal.FilterChainImpI.doFilter(FilterChainImpI.java:78)
atcom.company.test.authorization.OICStopModeFilter.doFilter(OICStopMode

Filter.java:48)

| | |
|---|---|
| | atappserver.servlet.internal.FilterChainImpI.doFilter(FilterChainImpI.java:78) |
| | atcom.company.test.authorization.TrackingFilter.doFilter(TrackingFilter.java:1 |
| 74) | atappserver.servlet.internal.FilterChainImpI.doFilter(FilterChainImpI.java:78) |
| | atcom.company.test.service.inject.LocaleFilter.doFilter(LocaleFilter.java:35) |
| | atappserver.servlet.internal.FilterChainImpI.doFilter(FilterChainImpI.java:78) |
| | atcom.company.test.rs.servlet.BodyConsumptionFilter.doFilter(BodyConsump |

tionFilter.java:27)

atappserver.servlet.internal.FilterChainImpI.doFilter(FilterChainImpI.java:78)
atcompany.security.jps.ee.http.JpsAbsFilter$3.run(JpsAbsFilter.java:172)
atjava.security.AccessController.doPrivileged(NativeMethod)
atcompany.security.jps.util.JpsSubject.doAsPrivileged(JpsSubject.java:315)
atcompany.security.jps.ee.util.JpsPlatformUtil.run JaasMode(JpsPlatformUtil.j

ava:650)

atcompany.security.jps.ee.http.JpsAbsFilter.runJaasMode(JpsAbsFilter.java:1

10)

| | |
|---|---|
| | atcompany.security.jps.ee.http.JpsAbsFilter.doFilterInternal(JpsAbsFilter.java: |
| 273) | atcompany.security.jps.ee.http.JpsAbsFilter.doFilter(JpsAbsFilter.java:147) |
| | atcompany.security.jps.ee.http.JpsFilter.doFilter(JpsFilter.java:94) |
| | atappserver.servlet.internal.FilterChainImpI.doFilter(FilterChainImpI.java:78) |
| | atcompany.dms.servlet.DMSServletFilter.doFilter(DMSServletFilter.java:248) |
| | atappserver.servlet.internal.FilterChainImpI.doFilter(FilterChainImpI.java:78) |
| | atcompany.jrf.servlet.ExtensibleGlobalFilter.doFilter(ExtensibleGlobalFilter.jav |
| a:92) | atappserver.servlet.internal.FilterChainImpI.doFilter(FilterChainImpI.java:78) |
| | atappserver.servlet.internal.RequestEventsFilter.doFilter(RequestEventsFilter |
| .java:32) | atappserver.servlet.internal.FilterChainImpI.doFilter(FilterChainImpI.java:78) |
| | atappserver.servlet.internal.WebAppServletContext$ServletInvocationAction. |

wrapRun(WebAppServletContext.java:3688)

atappserver.servlet.internal.WebAppServletContext$ServletInvocationAction.r

un(WebAppServletContext.java:3654)

atappserver.security.acl.internal.AuthenticatedSubject.doAs(AuthenticatedSu

bject.java:328)

atappserver.security.service.SecurityManager.runAsForUserCode(SecurityM

anager.java:197)

atappserver.servlet.provider.WIsSecurityProvider.runAsForUserCode(WIsSec

urityProvider.java:203)

atappserver.servlet.provider.WIsSubjectHandle.run(WIsSubjectHandle.java:7

1)

atappserver.servlet.internal.WebAppServletContext.doSecuredExecute(Web

AppServletContext.java:2433)

atappserver.servlet.internal.WebAppServletContext.securedExecute(WebApp

ServletContext.java:2281)

atappserver.servlet.internal.WebAppServletContext.execute(WebAppServlet

Context.java:2259)

atappserver.servlet.internal.ServletRequestImpI.runInternal(ServletRequestIm

pI.java:1692)

atappserver.servlet.internal.ServletRequestImpI.run(ServletRequestImpI.java:

1652)

atappserver.servlet.provider.ContainerSupportProviderImpI$WIsRequestExec

utor.run(ContainerSupportProviderImpI.java:272)

atappserver.invocation.ComponentInvocationContextManager._runAs(Compo

nentInvocationContextManager.java:348)

atappserver.invocation.ComponentInvocationContextManager.runAs(Compon

entInvocationContextManager.java:333)

atappserver.work.LivePartitionUtility.doRunWorkUnderContext(LivePartitionUt

ility.java:54)

atappserver.work.PartitionUtility.runWorkUnderContext(PartitionUtility.java:41

)

atappserver.work.SelfTuningWorkManagerImpI.runWorkUnderContext(SelfTu

ningWorkManagerImpI.java:640)

atappserver.work.ExecuteThread.execute(ExecuteThread.java:406)
atappserver.work.ExecuteThread.run(ExecuteThread.java:346)]]

We claim:

1. A method for generating machine learning recommendations using log data, the method comprising:
ingesting log data to generate an event stream for a plurality of cloud systems, wherein each of the plurality of cloud systems comprises a combination of components, and the plurality of cloud systems present heterogenous system architectures;
processing the generated event streams to generate a data set, wherein the data set comprises issue labels for issues experienced by the plurality of cloud systems;
extracting features from the generated data set; and
generating issue recommendations using a plurality of machine learning algorithms based on the extracted features and the generated data set, wherein the issue recommendations are generated using a hybrid of collaborative based machine learning filtering and content based machine learning filtering.

2. The method of claim 1, wherein the heterogenous system architectures comprise different mixes of the components.

3. The method of claim 2, wherein at least a portion of the heterogenous system architectures comprise independent cloud systems that are hosted in different cloud environments for different cloud customers.

4. The method of claim 2, wherein each issue label is defined based on a distinct sequence of log data from the event streams, the distinct sequences being representative of the issue labels.

5. The method of claim 4, wherein module IDs associated with the components that comprise the plurality of cloud systems are determined from the log data, and processing the generated event streams to generate the data set comprises encoding the log data from the event streams with the module IDs.

6. The method of claim 5, wherein the distinct sequences of log data are defined using distinct sequences of module IDs.

7. The method of claim 4, wherein the collaborative based machine learning filtering generates a first recommendation score for the issue labels in the data set, the first recommendation score being based on issue embeddings defined in a shared latent space.

8. The method of claim 7, wherein the shared latent space comprises a latent space that maps at least portion of the heterogeneous system architectures to a weight set and at least portion of the issue labels to the weight set.

9. The method of claim 7, wherein the content based machine learning filtering generates a second recommendation score for the issue labels in the data set, the second recommendation score being based on a similarity between issue parameters for at least two issue labels.

10. The method of claim 9, wherein the issue parameters comprise a stack trace for one or more errors related to the at least two issue labels.

11. The method of claim 9, wherein the issue recommendations are generated using a combination of the first recommendation score and the second recommendation score.

12. The method of claim 11, wherein the combination comprises a weighted average of the first recommendation score and the second recommendation score.

13. A system for generating machine learning recommendations using log data, the system comprising:
a processor; and
a memory storing instructions for execution by the processor, the instructions configuring the processor to:
ingest log data to generate an event stream for a plurality of cloud systems, wherein each of the plurality of cloud systems comprises a combination of components, and the plurality of cloud systems present heterogenous system architectures;
process the generated event streams to generate a data set, wherein the data set comprises issue labels for issues experienced by the plurality of cloud systems;
extract features from the generated data set; and
generate issue recommendations using a plurality of machine learning algorithms based on the extracted features and the generated data set, wherein the issue recommendations are generated using a hybrid of collaborative based machine learning filtering and content based machine learning filtering.

14. The system of claim 13, wherein the heterogenous system architectures comprise different mixes of the components, and at least a portion of the heterogenous system architectures comprise independent cloud systems that are hosted in different cloud environments for different cloud customers.

15. The system of claim 14, wherein each issue label is defined based on a distinct sequence of log data from the event streams, the distinct sequences being representative of the issue labels.

16. The system of claim 15, wherein module IDs associated with the components that comprise the plurality of cloud systems are determined from the log data, processing the generated event streams to generate the data set comprises encoding the log data from the event streams with the module IDs, and the distinct sequences of log data are defined using distinct sequences of module IDs.

17. The system of claim 15, wherein the collaborative based machine learning filtering generates a first recommendation score for the issue labels in the data set, the first recommendation score being based on issue embeddings defined in a shared latent space, the shared latent space comprising a latent space that maps at least portion of the heterogeneous system architectures to a weight set and at least portion of the issue labels to the weight set.

18. The system of claim 17, wherein the content based machine learning filtering generates a second recommendation score for the issue labels in the data set, the second recommendation score being based on a similarity between issue parameters for at least two issue labels, the issue parameters comprising a stack trace for one or more errors related to the at least two issue labels.

19. The system of claim 18, wherein the issue recommendations are generated using a combination of the first recommendation score and the second recommendation score.

20. A non-transitory computer readable medium having instructions stored thereon that, when executed by a processor, cause the processor to generate machine learning recommendations using log data, wherein, when executed, the instructions cause the processor to:
ingest log data to generate an event stream for a plurality of cloud systems, wherein each of the plurality of cloud systems comprises a combination of components, and the plurality of cloud systems present heterogenous system architectures;
process the generated event streams to generate a data set, wherein the data set comprises issue labels for issues experienced by the plurality of cloud systems;
extract features from the generated data set; and
generate issue recommendations using a plurality of machine learning algorithms based on the extracted features and the generated data set, wherein the issue recommendations are generated using a hybrid of collaborative based machine learning filtering and content based machine learning filtering.
